(19) United States
(12) Patent Application Publication
(10) Pub. No.: US 2019/0325360 A1
(43) Pub. Date: Oct. 24, 2019

(54) EFFECTIVENESS OF COMMUNICATIONS

(71) Applicant: International Business Machines Corporation, Armonk, NY (US)

(72) Inventors: Joseph LAM, Markham (CA); Trudy L. HEWITT, Cary, NC (US)

(21) Appl. No.: 16/459,670

(22) Filed: Jul. 2, 2019

Related U.S. Application Data
(63) Continuation of application No. 15/429,232, filed on Feb. 10, 2017.

(51) Int. Cl. G06Q 10/06; G06Q 10/10

(52) U.S. Cl. CPC G06Q 10/06; G06N 20/00; G06Q 10/0633; G06Q 10/10

(57) ABSTRACT

A cognitive computing system for improve effectiveness of communications among multiple members is disclosed. The cognitive computing system receives real-time information representing communications among a plurality of members through a plurality of communication media. For each of the plurality of members, the cognitive computing system classifies the member into one of a plurality of personalities, based on respective attributes of communications determined by analyzing responses of the member to the communications based on the real-time information. For a member, the cognitive computing system calculates an impact value representing an estimated impact of the personalities of the members on an effectiveness of future communications with the member. The cognitive computing system provides recommendations for the future communications with the member that mitigate the estimated impact so as to improve the effectiveness of the future communications.

### CROSS-REFERENCE TO RELATED APPLICATIONS

This application is a continuation of co-pending U.S. patent application Ser. No. 15/429,232, filed Feb. 10, 2017. The aforementioned related patent application is herein incorporated by reference in its entirety.

### BACKGROUND

The present disclosure relates to improving effectiveness of communications, and more specifically, to improving effectiveness of communications among a plurality of people via cognitive computing technologies.

Personalities of people may negatively affect the effectiveness of interpersonal communications. For example, in a working group, the group leader could be an extrovert who is also aggressive. However, other group members could be introverts who perform best when they are given enough time to consider and express their thoughts and ideas. In teleconferences and email communications, the group leader may typically dominate the conversations/discussions and not give enough time for the members to provide their thoughts before arriving at a decision. Due to the clash of personalities and the failure of the group leader to recognize the clash of personalities, the communications between the extroverted group leader and the introverted group members in the present example are ineffective, and the working group may perform poorly as a result.

### SUMMARY

One embodiment of the present disclosure provides a method. The method includes receiving real-time information representing a set of communications among a plurality of members through a plurality of communication media. The method also includes, for each of the plurality of members, classifying the member into one of a plurality of personalities, based on respective attributes of communications determined by analyzing responses of the member to the set of communications based on the real-time information. The method further includes, for at least one of the plurality of members, calculating an impact value representing an estimated impact of the respective personalities of the members on an effectiveness of future communications with the at least one member, and providing recommendations for the future communications with the at least one member that mitigate the estimated impact so as to improve the effectiveness of the future communications with the at least one member.

### BRIEF DESCRIPTION OF THE SEVERAL VIEWS OF THE DRAWINGS

FIG. 1 illustrates a cognitive computing system, according to one embodiment described herein.

FIG. 2 illustrates improving effectiveness of communications through the cognitive computing system, according to one embodiment described herein.

FIG. 3 illustrates inputs and output of an impact estimator in the cognitive computing system, according to one embodiment described herein.

FIG. 4 illustrates tracking effectiveness of communications through a user interface, according to one embodiment described herein.

FIG. 5 is a flow chart illustrating a method of improving effectiveness of communications, according to one embodiment described herein.

### DETAILED DESCRIPTION

The present disclosure provides a solution of improving effectiveness of communications among a plurality of individuals through a cognitive computing system. In one embodiment, the cognitive computing system receives real-time information representing a set of communications among a plurality of members through a plurality of communication media. For each of the plurality of members, the cognitive computing system classifies the member into one of a plurality of personalities, based on respective attributes of communications determined by analyzing responses of the member to the set of communications based on the real-time information. For a member, the cognitive computing system calculates a respective impact value representing an estimated impact of the personalities of the members on an effectiveness of future communications with the member. The cognitive computing system provides recommendations for the future communications with the member that mitigate the estimated impact so as to improve the effectiveness of the future communications with the member. The cognitive computing system tracks over time whether the recommendations indeed improve the effectiveness of the future communications with the member. The cognitive computing system updates the recommendations based on the tracked results.

One advantage of the present disclosure provides that the cognitive computing system identifies the personality of every member automatically by analyzing responses of each member to the communications and provides recommendations for future communications among the members automatically. Thus, the members do not need to know the personality of each other by themselves and determine how to communicate with each other effectively by themselves. Instead, the members simply need to follow the recommendations provided by the cognitive computing system. Another advantage of the present disclosure provides that the cognitive computing system automatically tracks whether the recommendations indeed improve the effectiveness of future communications and updates the recommendations if necessary. Thus, the members do not need to ask each other whether the communications are effective among each other and whether changes of the communications are needed. Instead, the cognitive computing system notifies the members whether the communications are effective and instructs the members to make changes to the communications if necessary.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the following, reference is made to embodiments presented in this disclosure. However, the scope of the present disclosure is not limited to specific described embodiments. Instead, any combination of the following features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.”

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Embodiments of the invention may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud computing resources are provided to a user on a pay-per-use basis, where users are charged only for the computing resources actually used (e.g. an amount of storage space consumed by a user or a number of virtualized systems instantiated by the user). A user can access any of the resources that reside in the cloud at any time, and from anywhere across the Internet. In context of the present disclosure, the cognitive computing system could execute on a computing system in the cloud. In such a case, the cognitive computing system could identify personalities of a plurality of members and store personalities of the members at a storage location in the cloud. Doing so allows a user to access the stored information from any computing system attached to a network connected to the cloud (e.g., the Internet).

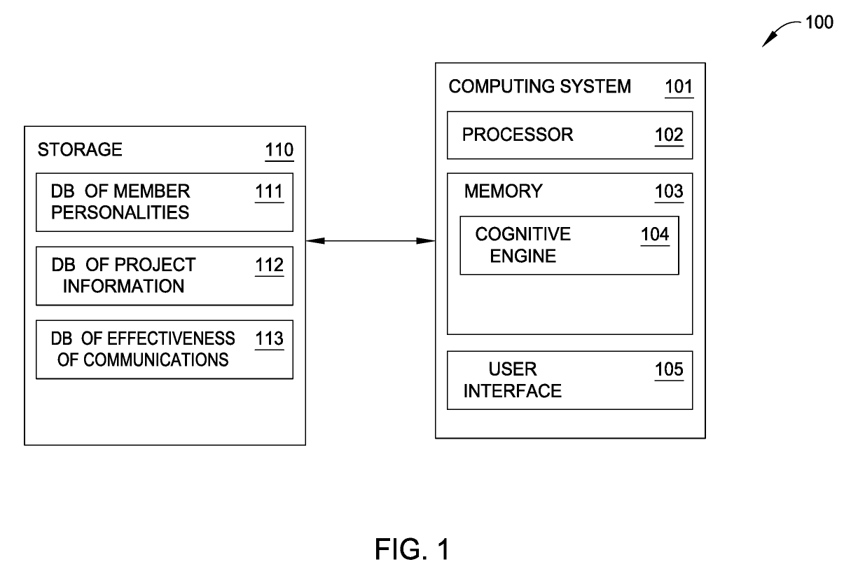

FIG. 1 illustrates a cognitive computing system 100, according to one embodiment herein. The cognitive computing system 100 includes a computing system 101. The computing system 101 includes a processor 102, a memory 103 and a user interface (UI) 105. The processor 102 may be any computer processor capable of performing the functions described herein. Although memory 103 is shown as a single entity, memory 103 may include one or more memory devices having blocks of memory associated with physical addresses, such as random access memory (RAM), read only memory (ROM), flash memory or other types of volatile and/or non-volatile memory. The users can interact with the computing system 101 through the UI 105.

According to one embodiment, the memory 103 includes a cognitive engine 104. The cognitive engine 104 improves effectiveness of communications among a plurality of members based on personalities of the members, which will be described in details below.

The cognitive computing system 100 also includes storage 110. In one embodiment, the storage 110 includes a database (DB) of member personalities 111, a DB of project information 112 and a DB of effectiveness of communications 113. The computing system 101 communicates with the storage 110 to improve effectiveness of communications among a plurality of members. In one embodiment, the storage 110 may be included in the computing system 101. In another embodiment, the computing system 101 may access the storage 110 through a communication network, e.g., a local area network (LAN) or a wide area network (WAN), or the Internet (not shown in FIG. 1). In another embodiment, the storage 110 may be located in a cloud computing system.

In one embodiment, the cognitive engine 104 identifies personalities of a plurality of members in a group and stores information of personalities of the members in the DB of member personalities 111. That is, the DB of member personalities 111 stores information of the personality of each member in the group.

In one embodiment, the DB of project information 112 stores information of one or more projects that the members in the group are working on. For example, the information stored in the DB of project information 112 can indicate that a project is a creative and technical project that has a short go-to-market time. In one embodiment, the cognitive engine 104 provides recommendations to communications among the members working on a project by evaluating the information of the project stored in the DB of project information 112.

In one embodiment, the DB of effectiveness of communications 113 stores information indicating whether recommendations provided by the cognitive engine 104 improve the effectiveness of the communications among the members in one or more projects that the members are working on. In one embodiment, the cognitive engine 104 tracks over time whether the recommendations indeed mitigate the impact of the personalities of the members on the effectiveness of communications. The cognitive engine 104 sends the tracked results to the DB of effectiveness of communications 113. For example, if the cognitive engine 104 tracks that the recommendations indeed mitigate the impact of the personalities of the members on the effectiveness of communications in a project, the cognitive engine 104 sends positive results to the DB of effectiveness of communications 113 indicating that the recommendations indeed improve the effectiveness of the communications among the members in the project. In another example, the DB of effectiveness of communications 113 can further store a mapping between the recommendations and the project in which the recommendations improve the effectiveness of the communications among the members. The mapping can be used as guidelines for future projects.

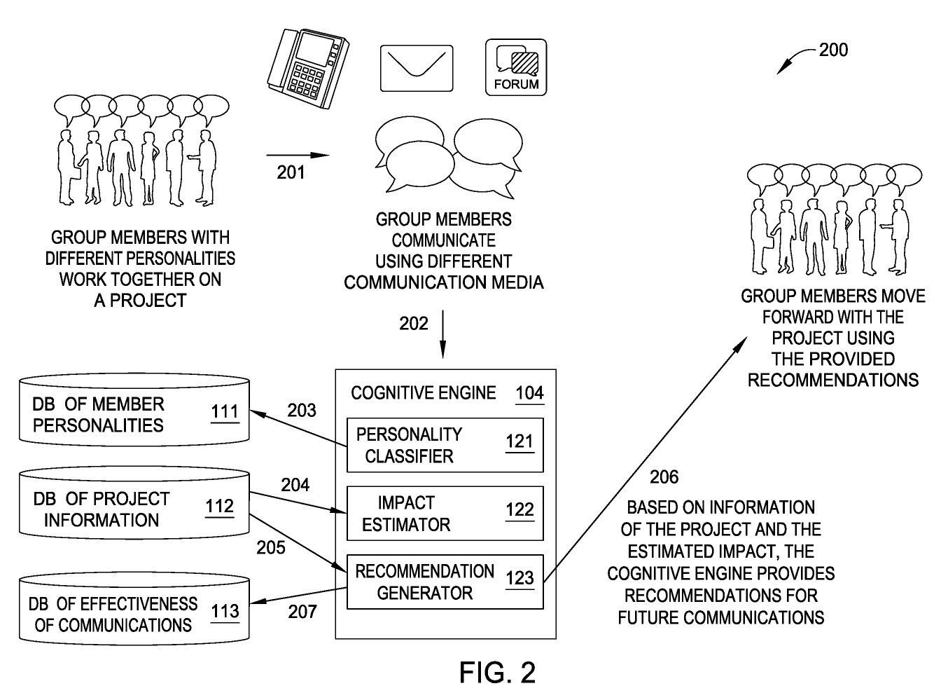

FIG. 2 illustrates improving effectiveness of communications through the cognitive computing system 100, according to one embodiment described herein. As shown in FIG. 2, multiple group members with different personalities work together on a project. The members communicate/interact with each other when working together on the project, as indicated by arrow 201 in FIG. 2. The multiple group members communicate with each other using different communication media such as phone calls, teleconferences, emails, text messages, online forum discussions, online chat room discussions and other electronic communication media as understood in the art.

In one embodiment, the cognitive engine 104 receives real-time information of a set of communications/interactions among the members without requiring the members' active input to the cognitive engine 104, as indicated by arrow 202 in FIG. 2. In one embodiment, the cognitive engine 104 can be located in a central network server. The central network server stores and/or records all the electronic communications among the members through the network (e.g., Internet and telephone network) and provides real-time information of the set of communications among the members to the cognitive engine 104. In one embodiment, the real-time information includes time and contents of the communications, involvements/participations of the members in the communications, and/or responses of the members to the communications. For examples, the real-time information can include contents (e.g., words or sentences) of online chat room discussions between a member A and a member B, and how many times member A speaks in teleconferences that other members attend, and how long member A responds to emails sent from member B. In another embodiment, the set of communications includes real-time communications among the members in a certain time period, e.g., on weekdays from 9:00 am to 5:00 pm.

In one embodiment, the cognitive engine 104 includes a 203206 121 to receive and scan the real-time information of the communications/interactions. In one embodiment, the personality classifier 121 determines attributes of communications for each member by analyzing responses of the member to the set of communications based on the real-time information. For example, the personality classifier 121 can analyze responses of member A to the communications and determine that member A rarely speaks in teleconferences that other members attend but he replies emails with long contents after he is given enough time.

In another embodiment, the personality classifier 121 can determine attributes of communications indicating personal relationships among the members. For example, the personality classifier 121 can determine an attribute that member A always delays to respond to emails sent from member B, but member A replies emails from other members timely. This attribute may indicate that the personal relationships between member A and member B is not good.

In one embodiment, the personality classifier 121 classifies each member into one of a plurality of personalities, based on the attributes of communications of each member. In one embodiment, the personality classifier 121 predefines a plurality of personalities such as extrovert, introvert, aggressive and passive. The personality classifier 121 could then be trained using a training data set to learn how to classify a user as one of the plurality of personalities, based on a set of communications made by the user. In one embodiment, the training data set includes multiple known or pre-defined attributes of communications that can be used to train the personality classifier 121 to recognize which personality a given input (e.g., emails, instant messages, phone calls, etc. made by a user) best corresponds to. For example, each known or pre-defined attribute of communications can correspond to a pre-defined personality. The personality classifier 121 learns to recognize each attribute of communications and how they relate to the plurality of personalities, and in doing so, learns how to classify a set of communications made by a user to a corresponding personality.

For example, the training data set could include multiple previously conducted online chat room discussions in which a member frequently uses aggressive words or phrases, e.g., “you have to”, “you must” or “you should” in 90% of the online chat room discussions. This training data could correspond to the behavior of a user with an aggressive personality in an online chat room. The central network server can store the previously conducted online chat room discussions (e.g., the online chat room discussions conducted last month) and provide it for use in training the personality classifier 121. In another example, the training data can be multiple previously conducted teleconferences that a member speaks in more than 70% of the teleconferences. This training data corresponds to an extrovert personality. The training data could be used to train the personality classifier 121, such that the personality classifier 121 effectively learns how a member with an aggressive personality communicates in online chat room discussions. Similarly, the personality classifier 121 can learn that if a member speaks actively in most (e.g., more than 70%) of the teleconferences, this member has an extrovert personality.

After the training process, the personality classifier 121 implements a machine learning model (e.g., a statistical model) to determine each member's personality based on the attributes of communications, as learned in the training process explained above. In one embodiment, the personality classifier 121 implements the machine learning model to identify statistic features in attributes of communications for a member and determines which personality matches the attributes best. For example, the input to the personality classifier 121 indicates that member B speaks in 70% of the teleconferences and uses aggressive words in 30% of the online chat room discussions. The personality classifier 121 can identify the statistic features (e.g., 70% and 30%) and determines that the extrovert personality matches member B's attributes of communications best. Thus, the personality classifier 121 classifies member B as an extrovert.

In one embodiment, a personality corresponds to multiple attributes. For example, the extrovert personality may correspond to two attributes. One attribute can be a measure of activity in speaking in teleconferences as explained above. Another attribute may be a frequency of making phone calls for a particular topic. In one embodiment, the personality classifier 121 determines the personality of a member with a confidence factor. The confidence factor can be a percentage indicating the possibility of the member having the determined personality. For example, if a member has one of the two above attributes mentioned in this paragraph, the personality classifier 121 determines that the member is an “extrovert” with a confidence factor such as 60%. In another example, if a member has both of the two above attributes mentioned in this paragraph, the personality classifier 121 determines that the member is an “extrovert” with a confidence factor such as 90%.

In one embodiment, the personality classifier 121 determines multiple personalities for a member. For example, the personality classifier 121 can determine that member C has an “extrovert” personality because member C has an attribute of active speaker in teleconferences. In the meanwhile, the personality classifier 121 can determine that member C also has an “aggressive” personality because member C uses aggressive words in most of the online chat room discussions.

Returning to FIG. 2, after determining the personalities for each member based on the attributes of communications of each member, the personality classifier 121 stores the information of the personality of each member in the DB of member personalities 111, as indicated by arrow 203 in FIG. 2. The stored information in the DB of member personalities 111 can be used to improve effectiveness of communications among the members for future projects.

In one embodiment, the personality classifier 121 sends the information of the personality of each member to an impact estimator 122 in the cognitive engine 104. The impact estimator 122 estimates an impact of the personalities of the members on an effectiveness of future communications in the project. For example, currently other members communicate with an introvert member A mainly through teleconferences. The impact estimator 122 can estimate that there is a negative impact on the effectiveness of communications to member A if other members still communicate with member A mainly through teleconferences in future communications. This is because member A does not like to speak in teleconferences to express his thoughts and ideas due to his introvert personality.

In one embodiment, the impact estimator 122 also obtains the information of the project that the members are working on from the DB of project information 112, as indicated by arrow 204 in FIG. 2. For example, the impact estimator 122 obtains the information of a project from the DB of project information 112 indicating that the project is a creative and technical project that has a short go-to-market time. Currently, the members communicate with each other mainly through emails. The impact estimator 122 can estimate that there is a negative impact on the effectiveness of communications if the members still communicate manly through emails in future communications. This is because email communications may cause unacceptable delays in the project requiring a short go-to-market time.

In one embodiment, the impact estimator 122 calculates a respective impact value for each member representing the estimated impact of the personalities of the members to each member in future communications. For example, the impact value for a member can be “positive” “neutral” or “negative”. In another example, the impact value can be a number from 0 to 1. For a member, a higher impact value indicates a more negative impact of the personalities of the members to that member on an effectiveness of future communications with that member. For example, the impact estimator 122 calculates that the impact value for member A is 0.8, which indicates that the future communications with member A is ineffective due to the negative impact of the personalities of other members to member A (e.g., clash of personalities between member A and other members).

In one embodiment, the impact estimator 122 could be trained using a training data set to learn how to estimate an impact for a member, based on the personality of the member and the personalities of other members that communicate with the member, and also based on the set of communications with the member. In one embodiment, the administrator of the cognitive engine can send surveys to the members. The survey can prompt each member to answer whether the impact of the communications between other members and the member is positive, neutral or negative. The survey can also prompt the member to answer why the impact of the communications to the member is negative. Based on the survey information, the impact estimator 122 learns how to estimate an impact for a member, based on the personality of the member and the personalities other members that communicate with the member, and also based on the set of communications made between other members and the member.

For example, the training data can be past attributes of communications indicating that member B was aggressive in online chat room discussions and also the survey results show that the aggressive way of communications made by the aggressive member B in online chat room discussions had a negative impact to a passive member D. Using this training data, the impact estimator 122 can learn that an aggressive way of communications in online chat room discussions has a negative impact to a passive member. In another example, the impact estimator 122 can calculate a numerical value indicating the extent of the impact. In one embodiment, the impact value can be a number from 0 to 1, as explained above. For example, if the survey results show that the aggressive way of communications made by member B in online chat room discussions had a highly negative impact to member D, the impact estimator 122 can learn that an aggressive way of communications in online chat room discussions has a high impact value, e.g., 0.8, to a passive member.

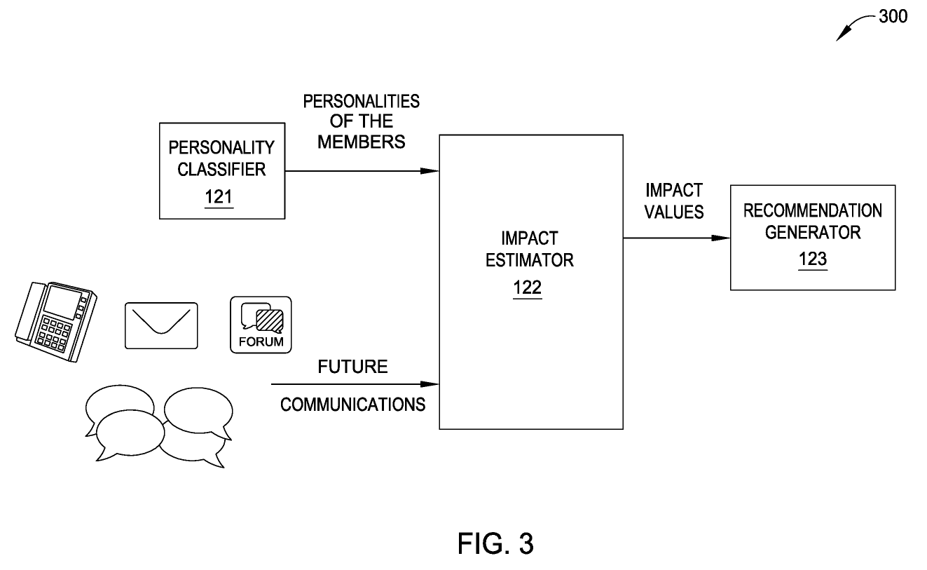

After the training process, the impact estimator 122 could implement a regression model to calculate the impact value for each member. In one embodiment, the impact estimator 122 implements the regression model based on two inputs as shown in FIG. 3. FIG. 3 shows the impact estimator 122 with two inputs to calculate the impact value, according to one embodiment described herein. The first input includes the personality of each member, provided by the personality classifier 121. The second input includes the future communications. In one embodiment, before the future communications, e.g., emails or text messages, are sent to members, the future communications are first input to the impact estimator 122 to estimate the impact of the personalities of the members.

In one embodiment, the impact estimator 122 can perform a regression analysis based on the two inputs to estimate or predict the impact to the future communications caused by the personalities of the members. For example, the impact estimator 122 can scan future communications to determine attributes of the future communications, e.g., aggressive words used in the future communications or communication media used in the future communications with a member. For each member, the impact estimator 122 can perform a regression analysis to predict whether the impact to the future communications is positive or negative given each member's personality, as learned in the training process explained above. In another example, the impact estimator 122 can calculate a numerical impact value indicating the extent of the impact based on the two inputs, as learned in the training process explained above.

In one embodiment, the impact estimator 122 calculates a total impact value for the group by evaluating and/or combining the respective impact value for each member. For example, if the impact estimator 122 calculates that the respective impact value for each member is “negative” for most of the members, e.g., 60% of the members, the impact estimator 122 can calculate that the total impact value is “negative”. In another example, the impact estimator 122 can calculate the total impact value by weighting the respective impact value for each member, e.g., the group leader and normal members have different weights, as understood by an ordinary person in the art.

In one embodiment, the impact estimator 122 sends the calculated impact value to a recommendation generator 123 in the cognitive engine 104. The recommendation generator 123 provides recommendations for future communications among the plurality of members that mitigate the impact of personalities so as to improve the effectiveness of the future communications in the project. For example, the impact estimator 122 sends the calculated impact value “negative” for an introvert member A to the recommendation generator 123. The introvert member A prefers indirect communications and needs enough time to consider and express his thoughts and ideas. The recommendation generator 123 provides recommendations that other members communicate with the introvert member A using emails instead of conducting teleconferences and/or delay the communications asking for thoughts and ideas of the introvert member A for a time period, e.g., two days. In another example, the recommendation generator 123 provides recommendations that unaggressive words/phrases should be used when communicating with a passive member.

In one embodiment, the recommendation generator 123 also obtains the information of the project that the members are working on from the DB of project information 112, as indicated by arrow 205 in FIG. 2. For example, the recommendation generator 123 obtains the information of a project from the DB of project information 112 indicating that the project is a creative and technical project that has a short go-to-market time. Currently, the members communicate with each other mainly through emails. The recommendation generator 123 can provide a recommendation that the members communicate with each other mainly through teleconferences to avoid delays in the project.

In one embodiment, the recommendation generator 123 provides different recommendations to improve the effectiveness of the future communications among the members. For example, the recommendation generator 123 recommends that other members communicate with the introvert member A mainly using emails but the members communicate with each other mainly through teleconferences when the introvert member A is not involved in a step or subtask of the project.

In one embodiment, the recommendation generator 123 provides different recommendations to the members through the UI 105. For example, the group leader can check the recommendations provided by the recommendation generator 123 through the UI 105 and adopt the recommendations in future communications among the members. The group members continue to work on the project using the provided recommendations in future communications, as indicated by arrow 206 in FIG. 2.

In one embodiment, the cognitive engine 104 continues to monitor and scan the real time communications to evaluate or track whether the recommendations indeed mitigate the impact of the personalities of the members on the effectiveness of communications and improve the effectiveness of the communications. In one embodiment, the cognitive engine 104 tracks whether the recommendations indeed mitigate the impact of the personalities of the members on the effectiveness of communications for a certain time period, e.g., one week after the members adopt the recommendations. In one embodiment, the impact estimator 122 can calculate new impact values to estimate the impact of the personalities of the members on the effectiveness of communications that use part or all of the provided recommendations.

For example, if the impact value is changed from “negative” to “positive” or decreased from 0.9 to 0.4, the changing indicates that the recommendations indeed mitigate the impact of the personalities of the members on the effectiveness of communications and improve the effectiveness of the communications. In this situation, the recommendation generator 123 sends positive results to the DB of effectiveness of communications 113 indicating that the recommendations indeed improve the effectiveness of the communications among the members in the project, as indicated by arrow 207 in FIG. 2. In another example, the DB of effectiveness of communications 113 can further store a mapping between the recommendations and the project in which the recommendations improve the effectiveness of the communications among the members as future guidelines.

In another example, if the cognitive engine 104 tracks that the recommendations do not mitigate the impact of the personalities of the members on the effectiveness of communications in a project, the recommendation generator 123 sends negative results to the DB of effectiveness of communications 113 indicating that the recommendations do not improve the effectiveness of the future communications among the members in the project. In this example, the recommendation generator 123 can further provide updates to the recommendations. For example, if after using the recommendations to use emails to communicate with the introvert member A, the communications between member A and member B are still ineffective (e.g., the personality classifier 121 detects that member A always delays to reply to emails sent from member B). The reason may be that the personal relationship between A and B is not good. In this situation, the recommendation generator 123 can provide updated recommendations to recommend another person to communicate with member A using emails. In another example, if the group introduces multiple new members with extrovert personality, the recommendation generator 123 can provide updated recommendations to use more direct communications such as teleconferences when communicating with those new members

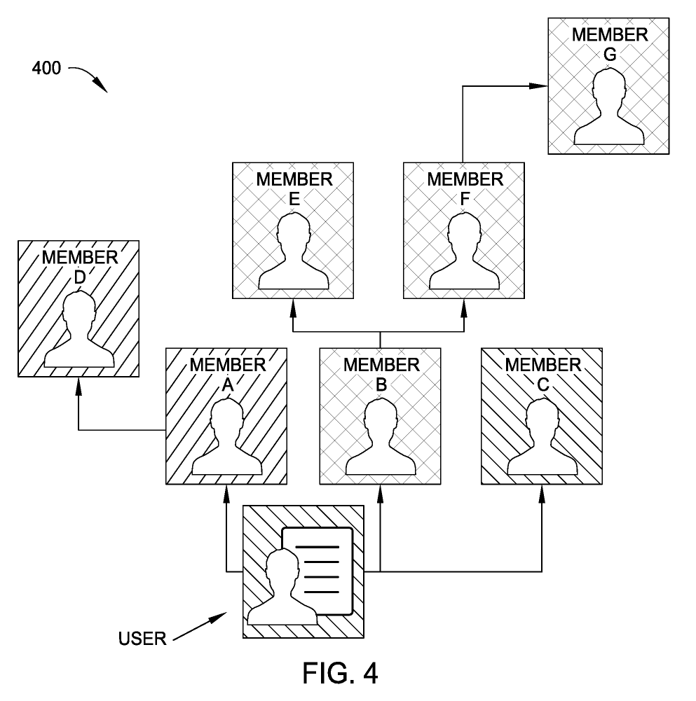

In one embodiment, the cognitive engine 104 tracks the recommendations using the UI 105 to provide visible results to the users. FIG. 4 shows tracking effectiveness of communications through the UI 105, according to one embodiment described herein. As shown in FIG. 4, the user, e.g., a group member, can check effectiveness of communications between the user and other group members through the UI 105. For example, without using the recommendations, the UI 105 shows that the personalities of the user and member B have a “negative” impact on effectiveness of communications between the user and member B. After using the recommendations, the UI 105 shows that the personalities of the user and member B have a “positive” impact on effectiveness of communications between the user and member B. In one example, the “positive”, “negative” or “neutral” impact can be shown by using different colors or shadings on each member in the UI 105. In another example, the UI 105 shows that the numerical impact value indicating the impact on effectiveness of communications between the user and member B is decreased after using the recommendations. In another example, the user, e.g., the group leader, can check effectiveness of communications among group members. For example, the UI 105 shows that currently the personalities of member F and member G have a “positive” impact on effectiveness of communications between member F and member G. This visible result indicates that current communications between member F and member G are effective and update of recommendations is not needed.

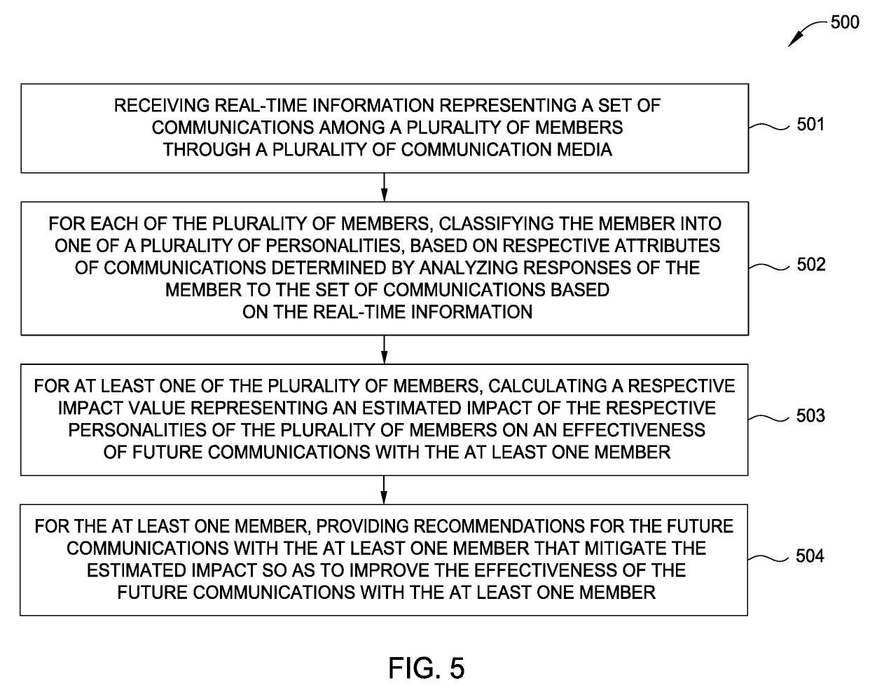

FIG. 5 is a flowchart that illustrates a method 500 of improving effectiveness of communications, according to one embodiment described herein. At block 501, the personality classifier 121 receives real-time information representing a set of communications among a plurality of members through a plurality of communication media. At block 502, for each of the plurality of members, the personality classifier 121 classifies the member into one of a plurality of personalities, based on respective attributes of communications determined by analyzing responses of the member to the set of communications based on the real-time information. At block 503, for a member, the impact estimator 122 calculates an impact value representing an estimated impact of the respective personalities of the members on an effectiveness of future communications with the member. At block 504, the recommendation generator 123 provides recommendations for the future communications with the member that mitigate the impact so as to improve the effectiveness of the future communications with the member.

The above embodiments show that the cognitive computing system can improve effectiveness of communications among multiple group members that are working together. In other embodiments, the cognitive computing system can also improve effectiveness of communications among people in other scenarios. For example, the cognitive computing system can also improve effectiveness of communications among family members. In another example, the cognitive computing system can also improve effectiveness of communications among friends on social networks.

While the foregoing is directed to embodiments of the present invention, other and further embodiments of the invention may be devised without departing from the basic scope thereof, and the scope thereof is determined by the claims that follow.

What is claimed is:

1. A method, comprising:
receiving real-time information representing a set of communications among a plurality of members through a plurality of communication media;
for each of the plurality of members, classifying the member into one of a plurality of personalities, based on respective attributes of communications determined by analyzing responses of the member to the set of communications based on the real-time information;
for at least one of the plurality of members, calculating a respective impact value representing an estimated impact of the respective personalities of the plurality of members on an effectiveness of future communications with the at least one member; and
for the at least one member, providing recommendations for the future communications with the at least one member that mitigate the estimated impact so as to improve the effectiveness of the future communications with the at least one member.

2. The method of claim 1, further comprising:
for the at least one member, determining whether the recommendations for the future communications mitigate the estimated impact.

3. The method of claim 2, further comprising:
for the at least one member, updating the recommendations for the future communications.

4. The method of claim 1, wherein the recommendations comprise using one or more different communication media in the future communications with the at least one member.

5. The method of claim 1, wherein the recommendations comprise delaying the future communications with at least one member.

6. The method of claim 1, wherein classifying the member into one of a plurality of personalities comprises matching the respective attributes of communications of the member with one of the plurality of personalities.

7. The method of claim 1, further comprising:
calculating an impact value representing an estimated impact of the respective personalities of the plurality of members on an effectiveness of future communications among the plurality of members based on respective impact value for each member.
